(19) United States
(12) Patent Application Publication
(10) Pub. No.: US 2014/0143146 A1
(43) Pub. Date: May 22, 2014

(54) SYSTEMS AND METHODS FOR GENERATING AND USING A TOKEN FOR USE IN A TRANSACTION

(71) Applicants: Prakash George PASSANHA, San Jose, CA (US); Jalpesh CHITALIA, San Jose, CA (US); Sireesh POTIREDDY, San Jose, CA (US); Ansar ANSARI, San Jose, CA (US)

(72) Inventors: Prakash George PASSANHA, San Jose, CA (US); Jalpesh CHITALIA, San Jose, CA (US); Sireesh POTIREDDY, San Jose, CA (US); Ansar ANSARI, San Jose, CA (US)

(21) Appl. No.: 13/931,702

(22) Filed: Jun. 28, 2013

Related U.S. Application Data
(60) Provisional application No. 61/728,726, filed on Nov. 20, 2012.

(51) Int. Cl. G06Q 20/40

(52) U.S. Cl. CPC G06Q 20/40
USPC 705/44

(57) ABSTRACT

Systems and methods are provided for generating and using a token for authorizing a payment to satisfy an agreement for goods and/or services. The token may be generated based on information related to the agreement, as well as a specified validity period and token type. The generated token may then be used within the specified validity period to authorize a payment to satisfy the agreement. The token may be a limited-use token having a predetermined number of uses, such that after the token has been used the predetermined number of times, the token may be destroyed such that the payment is not authorized more than the predetermined number of uses.

### CROSS REFERENCE TO RELATED APPLICATIONS

Pursuant to 35 U.S.C. §119(e), this application claims priority to the filing date of U.S. Provisional Patent Application No. 61/728,726, filed on Nov. 20, 2012, the disclosure of which is hereby incorporated by reference in its entirety.

### BACKGROUND

1. Technical Field

Embodiments disclosed herein are related to systems and methods for generating and using a token that may be used in a transaction. In particular, embodiments disclosed herein may generate a token that may be mapped to an agreement for an exchange of payment for goods and/or service, wherein the token may be redeemed in order to authorize payment and complete the agreement.

2. Related Art

The increased connectivity of people and the need for fast and secure payments over the internet has led to alternative payment systems that use this increased connectivity to the internet to handle payments. A user may now pay for goods and services using alternative payment systems, such as may be provided by a payment service processor, in addition to traditional payment systems, such as cash, credit cards, and checks. However, these alternative payment systems have been primarily implemented for network-based transactions that take place over the internet between parties over the internet, and not for transactions that take place in a traditional brick and mortar store. Due to the growth of mobile devices and connectivity to those devices the next step is bringing alternative payment systems to the brick and mortar stores and to the more traditional point of sale devices. A traditional point of sale device that may be able to receive card, cash, and checks as payment, but may not be able to process payments from an alternative payment system. And, if they are able to process payments from an alternative payment system, they may not be able to process different types of payments including payments made using a mobile device.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIG. 3 is a flow diagram illustrating the generation and use of a token, consistent with some embodiments.

FIG. 4 is a diagram illustrating a token, consistent with some embodiments.

FIG. 5 is a flowchart illustrating a method for generating a token, consistent with some embodiments.

FIG. 6 is a flowchart illustrating a method for authorizing a payment based on a received token, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Consistent with some embodiments, there is provided a system for generating a token for use in authorizing a payment. The system includes a network interface component configured to: receive an agreement for an exchange of the payment for goods or services, receive a validity period defining a period for which the token is valid, and receive a token type. The system also includes one or more processors configured to generate the token based on the validity period and token type and map the received agreement to the token. The system also includes a memory configured to store the received agreement.

Consistent with some embodiments, there is also provided a method for generating a token. The method includes steps of receiving an agreement for an exchange of payment for goods or services, receiving a validity period defining a period over which the token is valid, receiving a token type, generating the token based on the validity period and token type, and mapping the received agreement to the token. The method may be embodied in computer-readable media.

Consistent with some embodiments, there is further provided a method for authorizing a payment using a token. The method includes steps of receiving the token, authenticating the token, retrieving an agreement for an exchange of the payment for goods and/or services mapped to the token, and paying a merchant providing the goods and/or services from a user account according to terms of the retrieved agreement. The method may be embodied in computer-readable media.

Embodiments disclosed herein may allow a payment service provider to generate a token that may be sent to a user for use in authorizing a payment to complete an agreement. The token may be mapped to the agreement and allow the user to authorize the transactions in many different ways and/or allow a merchant to accept different forms of payment. Moreover, the token may include information related to the agreement, the merchant, and the user, and may be generated to have characteristics based on the needs or limitations of the merchant.

These and other embodiments will be described in further detail below with respect to the following figures.

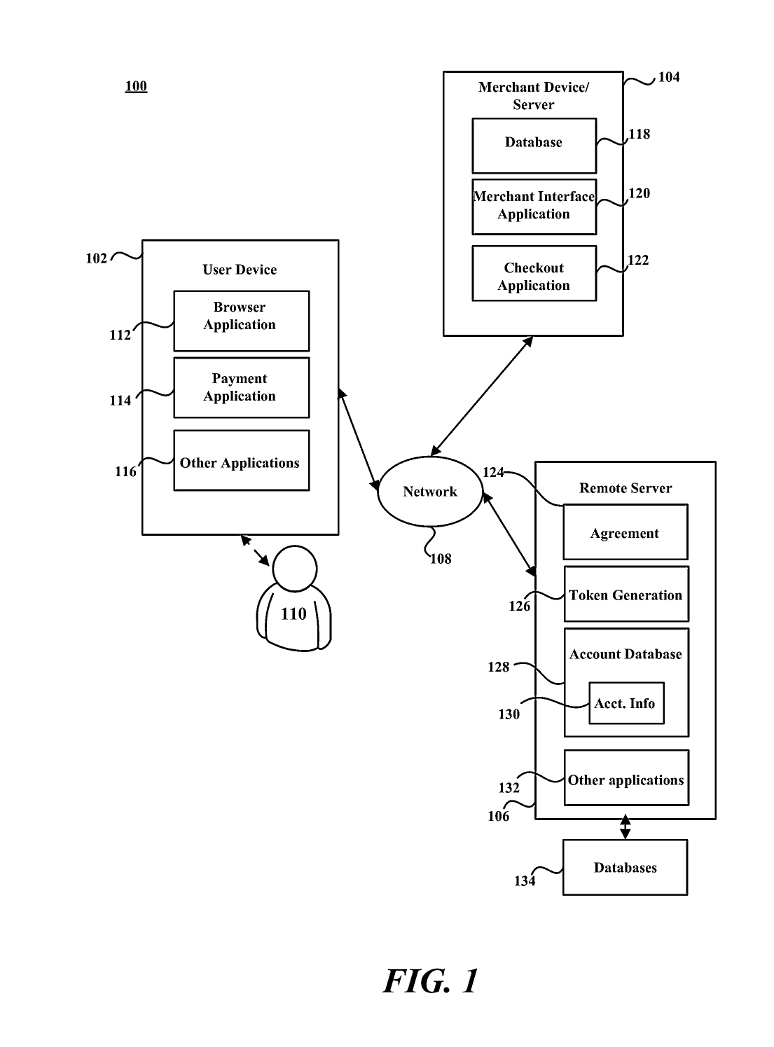

FIG. 1 is a block diagram of a networked system 100, consistent with some embodiments. System 100 includes a user device 102, a merchant server or device 104, and a remote server 106 in communication over a network 108. User 110 may be communicating with merchant server or device 104 and/or remote server 106 over network 108 using user device 102. Remote server 106 may be a payment service provider server that may be maintained by a payment provider, such as PayPal, Inc. of San Jose, Calif. Remote server 106 may be maintained by other service providers in different embodiments.

Network 108, in one embodiment, may be implemented as a single network or a combination of multiple networks. For example, in various embodiments, network 108 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

User device 102 may be a mobile device such as a smartphone, a tablet computer, a laptop or netbook, and the like. User device 102 may also be a personal computer, a set-top box (STB) such as provided by cable or satellite content providers, a video game system console, or a smart or internet-enabled television. User device 102 may also be a head-mounted display (HMD) or other wearable computing device. In some embodiments, user device 102 may be implemented in an automobile, for example in an entertainment center or console of an automobile, or is included or implemented in a healthcare device. User device 102 may be implemented using any appropriate combination of hardware and/or software configured for wired and/or wireless communication over network 108. Consistent with some embodiments, user device 102 may include any appropriate combination of hardware and/or software having one or more processors and capable of reading instructions stored on a non-transitory machine-readable medium for execution by the one or more processors. Consistent with some embodiments, user device 102 includes a machine-readable medium, such as a memory (not shown) that includes instructions for execution by one or more processors (not shown) for causing user device 102 to perform specific tasks. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read. Instructions stored on the machine-readable media may include instructions for authenticating user device 102 to remote server 106 to access services provided by remote server 106 and/or conducting financial transactions with remote server 106 for purchasing items offered by merchant server or device 104.

Such instructions may include instructions for displaying content by particular applications or “apps” stored in a memory of user device 102 and executed by one or more processors executing in user device 102. Example applications include a browser application 112 that displays content, such as a web page or a user interface using a browser, a payment application 114 that is used to make payments in conjunction with remote server 106 for goods and/or services to which the merchant and user 110 have agreed to exchange for the payment. Browser application 112 may be implemented as a web browser to view information available over network 108. Browser application 112 may include instructions executable by one or more processors for interfacing and communicating with remote server 106, a merchant interface provided by merchant server or device 104, or other servers managed by content providers or merchants via network 108. For example, user 110 may be able to access websites using browser 112 to find and agree to purchase goods and/or services from merchant having merchant device or server 104 through a payment service provider provided by remote server 106, such as PayPal, as well as access user account information or web content. In some embodiments, user 110 may be able to use payment application 114 to form agreements for payment for goods and services to be processed by remote server. Payment application 114 may be able to generate and/or receive from remote server 106 a limited-use token that may be mapped to an agreement to pay for goods and/or services. In some embodiments, the agreement to pay for goods and/or services may have an associated agreement identification (ID) and the limited-use token may be mapped to the agreement ID. Payment application 114 may further be able to interact with merchant server or device 104 to send a limited-use token, to form agreements to pay, to pay for goods and/or services, and to check in to the merchant or merchant device or server 104.

Other applications 116 may be desired in one or more embodiments to provide additional features available to user 110, including accessing a user account with remote server 106. For example, other applications 116 may include interfaces and/or communication protocols that allow the user to receive and transmit information through network 108 and to remote server 106 and other online sites. Other applications 116 may also include security applications for implementing client-side security features, programmatic client applications for interfacing with appropriate application programming interfaces (APIs) over network 108 or various other types of generally known programs and/or applications. Other applications 116 may include mobile apps downloaded and resident on user device 102 that enable user 110 to access content through the apps.

Merchant server or device 104 may be maintained, for example, by a merchant or seller offering various goods and/or services in exchange for payment to be received over network 108. In some embodiments, merchant server or device 104 may be a point of sale (POS) device maintained by a merchant in a physical store front that may be in communication with remote server 106 to form agreements with user 110 for the exchange of goods and services for payment to be processed by remote server 106. Consistent with some embodiments, merchant server or device 104 may be maintained by anyone or any entity that exchanges goods and/or services for a payment or otherwise receives payments, which includes charities as well as retailers and restaurants. Merchant server or device 104 includes a database 118 identifying available goods and/or services (which may be collectively referred to as items) which may be made available for viewing and purchase by user 110. Database 118 may include descriptions, images, and pricing of the items.

Merchant server or device 104 may also include a merchant interface application 120 which may be configured to serve information over network 108 to browser application 112 and/or payment application 114 of user device 102. In some embodiments, user 110 may interact with merchant interface application 120 through browser application 112 over network 108 in order to view various products, food items, or services identified in database 118. Merchant server or device 104 also includes a checkout application 122 which may be configured to facilitate the purchase by user 110 of goods or services identified by merchant interface application 120 or to form agreements for purchasing goods or services. Checkout application 122 may be configured to accept payment information from or on behalf of user 110 through remote server 106 over network 108. For example, checkout application 122 may receive and process a payment confirmation from remote server 106, as well as transmit transaction information to remote server 106 and receive information from remote server. Checkout application 122 may also be configured to accept one or more different funding sources for payment. Checkout application 122 may also be configured to accept limited-use tokens for payment, which may map to one or more agreements for purchase. In some embodiments, the limited-use tokens may be network code tokens or short codes tokens, in the form of an alphanumeric string or scannable code, as described in additional detail below.

Remote server 106, according to some embodiments, may be maintained by an online payment provider, such as PayPal, Inc. of San Jose, Calif., which may provide processing for online financial and information transactions on behalf of user 110. Remote server 106 may include agreement application 124, which may be adapted to interact with user device 102 and merchant server or device 104 to form agreements for the exchange of goods and/or services for a payment to be made by remote server 106 and/or store and process information received from user device 102 and merchant device or server 104 for forming agreements. Remote server 106 may also include a token generation application 126. In some embodiments, token generation application 126 may be capable of generating one or more limited-use tokens that map to an agreement formed by agreement application 124. The one or more limited-use tokens may designed to be used in a particular format, such as a code like as a bar code or Quick Response (QR) code that when scanned by merchant device or server 104 refer to an alphanumeric string token identifier that maps to an agreement. The one or more limited-use tokens may have a type, such as a network code token or a short code token that may be used by user 110 and/or payment application 114 of user device 102 to authorize the payment for goods and/or services to fulfill an agreement.

Remote server 106 also may maintain a plurality of user accounts in account database 128, each of which may include account information 130 associated with individual users. For example, account information 130 may include private financial information of users of remote server 106 such as account numbers, credentials, passwords, device identifiers, user names, phone numbers, credit card information, bank information, or other financial information which may be used to facilitate online transactions by user 110. Account information 130 may also include information that was captured by information collection application 118 and transmitted to remote server 106 over network 108. The captured information may be associated with a particular transaction and may be used to verify a transaction and/or used in resolving a dispute regarding a transaction using dispute resolution application. Remote server 106 may also include other applications 132. Such other applications 132 may include a payment processing application used to process and finalize payments made by user 110 pursuant to a formed agreement and a validation of a token that maps to the formed agreement. Other applications 132 may also include a transaction processing application, which may be part of a payment application or separate, may be configured to receive information from a user device 102 and/or merchant server or device 104 for processing and storage in one or more databases 134. The transaction processing application may include one or more applications to process account information 130 and/or a payment from user 110 through a user device 102 while on a website or app as described herein. A payment application may be further configured to determine the existence of and to manage accounts in account database 128 for user 110, as well as create new accounts if necessary.

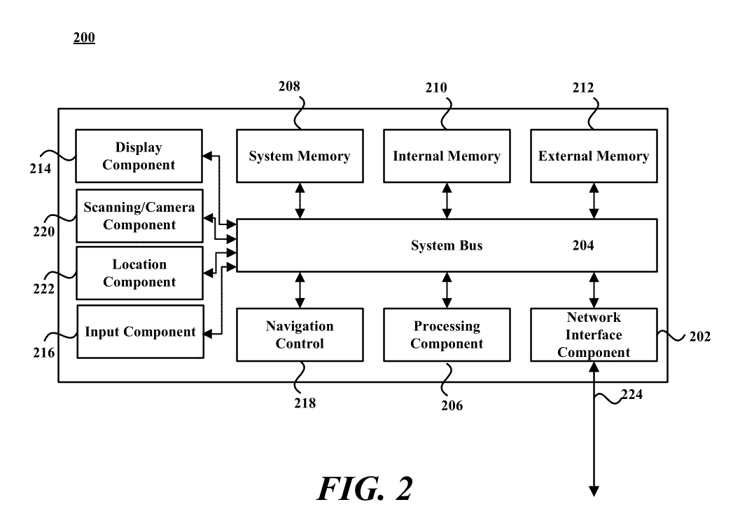

FIG. 2 is a diagram illustrating computing system 200, which may correspond to any of user device 102, merchant server or device 104, or remote server 106, consistent with some embodiments. Computing system 200 may be a mobile device such as a smartphone, a tablet computer, a laptop or netbook, and the like. Computing system 200 may also be a personal computer, a set-top box (STB) such as provided by cable or satellite content providers, a video game system console, or a smart or internet-enabled television. Computing system 200 may also be a head-mounted display (HMD) or other wearable computing device. In some embodiments, computing system 200 may be implemented in an automobile, for example in an entertainment center or console of an automobile, or is included or implemented in a healthcare device. Computing system 200 may also be a point-of-sale (POS) device. Further, computing system 200 may also be a server or one server amongst a plurality of servers. As shown in FIG. 2, computing system 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), near field communication (NFC), and/or infrared (IR) components configured for communication with network 108. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 108.

Consistent with some embodiments, computing system 200 includes a system bus 204 for interconnecting various components within computing system 200 and communication information between the various components. Such components include a processing component 206, which may be one or more processors, micro-controllers, or digital signal processors (DSP), graphics processing units (GPUs), a system memory component 208, which may correspond to random access memory (RAM), an internal memory component 210, which may correspond to read-only memory (ROM), and an external or static memory 212, which may correspond to optical, magnetic, or solid-state memories. Consistent with some embodiments, computing system 200 further includes a display component 214 for displaying information to a user 110 of computing system 200. Display component 214 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 216, allowing for user 110 of computing system 200 to input information to computing system 200. Such information could include payment information such as an amount required to complete a transaction, account information, authentication information, or identification information. An input component 216 may include, for example, a keyboard or key pad, whether physical or virtual. Computing system 200 may further include a navigation control component 218, configured to allow a user to navigate along display component 214. Consistent with some embodiments, navigation control component 218 may be a mouse, a trackball, or other such device. Moreover, if device 200 includes a touch screen, display component 214, input component 216, and navigation control 218 may be a single integrated component, such as a capacitive sensor-based touch screen or other touch screen. Further consistent with some embodiments, computing system 200 may include a scanning and camera component 220. Scanning and camera component 220 may be any mechanism that allows for the capture of images and/or scanning of bar, QR, or other codes.

Consistent with some embodiments, computing system 200 may include a location component 222 for determining a location of computing system 200. In some embodiments, location component 222 may correspond to a Global Positioning System (GPS) transceiver that is in communication with one or more GPS satellites. In other embodiments, location component 222 may be configured to determine a location of computing system 200 by using an internet protocol (IP) address lookup, or by triangulating a position based on nearby mobile communications towers. Location component 222 may be further configured to store a user-defined location in any of system memory 208, internal memory 210, and/or external memory 212 that can be transmitted to a third party for the purpose of identifying a location of computing system 200.

Computing system 200 may perform specific operations by processing component 206 executing one or more sequences of instructions contained in system memory component 208, internal memory component 210, and/or external or static memory 212. In other embodiments, hard-wired circuitry may be used in place of or in combination with software instructions to implement the present disclosure. Logic may be encoded in a computer readable medium, which may refer to any medium that participates in providing instructions to processing component 206 for execution. Such a medium may take many forms, including but not limited to, non-volatile media, volatile media, and transmission media. The medium may correspond to any of system memory 208, internal memory 210 and/or external or static memory 212. Consistent with some embodiments, the computer readable medium is non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 224 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 224 and network interface component 202. Communication link 224 may be wireless through a wireless data protocol such as Wi-Fi™, 3G, 4G, HSDPA, LTE, RF, NFC, or through a wired connection. Network interface component 202 may include an antenna, either separate or integrated, to enable transmission and reception via communication link 224. Received program code may be executed by processing component 206 as received and/or stored in memory 208, 210, or 212.

Computing system 200 may include more or less components than shown in FIG. 2 according to some embodiments. Moreover, components shown in FIG. 2 may be directly coupled to one or more other components in FIG. 2, eliminating a need for system bus 204. Furthermore, components shown in FIG. 2 may be shown as being part of a unitary system 200, but may also be part of a system where the components are separate but coupled and in communication. In general, the components shown in FIG. 2 are shown as examples of components in a computing system 200 capable of performing embodiments disclosed herein. However, a processing system 200 may have more or fewer components and still be capable of performing some embodiments disclosed herein.

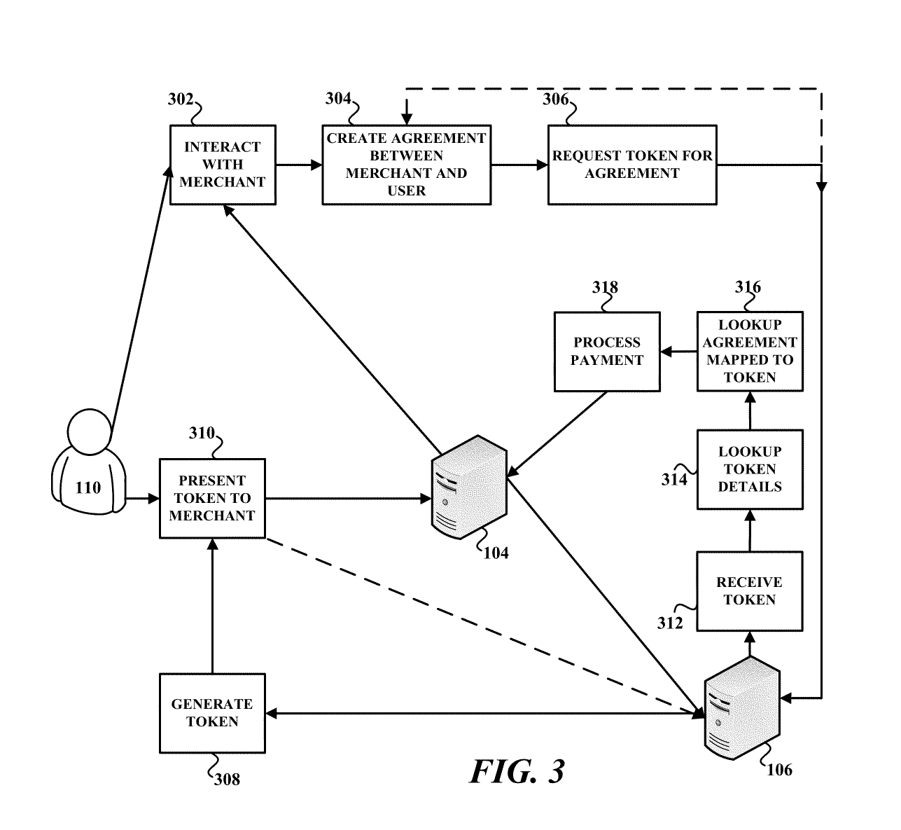

FIG. 3 is a flow diagram illustrating the generation and use of a token, consistent with some embodiments. For the purpose of illustration, FIG. 3 may be discussed with reference to FIGS. 1 and 2. As shown in FIG. 3, user 110 may be capable of paying for goods and/or services provided by a merchant, illustrated as merchant device or server 104, using a limited-use token that may be generated by remote server 106 and provided to user 110 on user device 102. In some embodiments, remote server 106 may receive an agreement between user 110 and merchant device or server 104 for the exchange of a payment for goods and/or services. The agreement may have or may be assigned an agreement ID. Remote server 106 may map this agreement or agreement ID to a limited-use token that may have a specific type and validity period as specified by merchant device or server 104 and/or user 102.

As shown in FIG. 3, user 110 using user device 102 may be able to make and form agreements for the exchange of goods and/or services provided by merchant device or server 104 for a payment. In some embodiments, the payment may be processed by remote server 106. Moreover, remote server 106 may receive information about the exchange from user 110 and merchant device or server 104, and agreement application 124 may form the agreement and store it in a memory, such as account database 128 or databases 134. The received information may include user 110 account information, merchant device or server 104 account information, the goods and/or services that are to be provided for the payment, and an amount of the payment. Remote server 106 may then receive a request to generate a token for the authorization of the payment to complete the agreement from user 110 using user device 102 or merchant device or server 104. The request may also include a validity period specifying for how long the token is to remain valid. In some embodiments, the request may also include a token type. In some embodiments, the token type may be set by the merchant such that tokens generated for use in fulfilling agreements with particular merchants have a specified token type. The request may also specify a particular token format or the format may be set based on the merchant, similar to the token type.

As shown in FIG. 3, user 110 and a merchant may interact 302 to create an agreement for the exchange for goods and/or services for a payment 304. In some embodiments, the interaction may be made over network 108. In some embodiments, the interaction over network 108 may be user 110 accessing goods and/or services from database 118 and selecting goods and/or services for purchase. In some embodiments, the interaction over network 108 may be user 110 checking into merchant device or server 104 and selecting goods and/or services for purchase from database 118. In some embodiments, the agreement may be created by checkout application 122 of merchant device or server 104 in communication with browser application 112 and/or payment application 114 of user device 102. In some embodiments, details of the agreement are sent by merchant device or server 104 and user device 102 to remote server 106, where agreement application 124 forms the agreement. The agreement may then be given an agreement ID that identifies the details of the agreement for use by remote server 106.

Remote server 106 may then receive a request to generate a token 306 that maps to the created agreement ID. In some embodiments, merchant interface application 120 and/or checkout application 122 of merchant device or server 104 may make the request for generating the token. In other embodiments payment application 114 of user device 102 may make the request for generating the token. The request to generate a token may include information such as a validity period, a token type and format, user and merchant details, and other relevant information. The request to generate the token may reference a formed agreement ID, or an agreement that is being formed between user 110 and merchant server or device 104. In some embodiments, payment application 114 of user device 102 may make the request for generating the token. For example, user 110 may request that remote server 106 generate a limited use token.

The type of token to be generated specified in the request may include a network code token and the format may include a scannable code, such as a bar code or QR code that can be displayed by user device 102 and scanned by a scanning/camera component 220 of merchant device or server 104. In some embodiments, remote server 106 may generate a network code token, transmit the network code token to user device 102 where payment application 114 or other applications 116 may generate a bar code or QR code based on the received network code token. In some embodiments, token generation application 126 of remote server 106 may generate the network code token and generate a QR code or bar code based on the generated network code token and then send the QR code or bar code to user device 102. User 110 may then use payment application 114 to display the QR or bar code and present it to a merchant for scanning to authorize a payment based on the agreed transaction.

In some embodiments, the token type may be specified as being a short code token. A short code token may be a token that includes token identifier including an alphanumeric string of characters that has less characters than a network code token. In some embodiments, a short code token may take the form of a temporary passcode or temporary personal identification number (PIN) that user 110 may use to authenticate to remote server 106 temporarily for the purpose of authorizing a payment for an agreement. In some embodiments, token generation application 126 of remote server 106 may generate a short code token and send the generated short code token to user device 102 over network 108. User 110 may then retrieve the short code token using payment application 114 and present the short code token to a merchant or enter it at merchant device or server 104. In some embodiments, the short code token may also be in the form of a scannable code, such as a bar code or a QR code that merchant device or server 104 can scan using scanning/camera component 220.

A request to generate a token may also include a validity period which may specify for how long the generated token is valid to be used to authorize a payment to complete an agreement. After the validity period has expired, the token will be considered to be expired. At this time, if user 110 attempts to use the token to perform a transaction, such as authorizing a payment, remote server 106 may decline the transaction. In some embodiments, however, merchant device or server 104 or user device 102 may agree to extend the validity period of the agreement which may result in the regeneration of the token or the in the generation of a new token that maps to the same agreement.

Token generation application 126 may then generate a token 308 based on the received request and send the token to user device 102. To authorize a payment to complete an exchange and fulfill an agreement, user 110 may then present the received token to the merchant 310. In some embodiments, user 110 may present the received token to the merchant by presenting the merchant with a QR code or bar code generated from the token, such that scanning/camera component 220 of merchant device or server 104 may scan the code. In some embodiments, user 110 may present the received token by entering an alphanumeric string corresponding to the token identifier at input component 116 of merchant device or server 104 or otherwise presenting the alphanumeric string to the merchant for entry into merchant device or server 104. Merchant device or server 104 may store the token and/or token details and then send the token to remote server 312. In some embodiments, user device 102 may send the token directly to remote server 106 to authorize a payment. Remote server 106 may then receive the token 312 and lookup the token details 314 and the agreement ID mapped to the token 316 and process the payment for the agreement 318. In some embodiments, remote server 106 may access payment details associated with user 110 in account information 130 for processing the payment for the agreement.

Once the token has been received by remote server 106 and used to authorize a payment, the token may be marked as having been used and destroyed such that it is not used to authorize a payment a second time if the token is a one use token. If the token is designed to have multiple uses, the use of the token will be noted such that a use number associated with the token may be decremented. The token may also be considered as being expired after an assigned validity period. Moreover, the token may be associated with recycling logic that determines when a token having the same alphanumeric string as a token identifier may be reused. Consequently, a merchant and user 110 can accept and make different types of payments using the token. The token maps to the agreement and serves as a pointer to the agreement so that remote server 106 can access the agreement and process a payment according to the agreement details and/or information included in the token. Although only a few types of payments have been disclosed herein, any type of payment that can be accepted by merchant device or server 104, used by user 110 using user device 102 and processed by remote server 106 can be used.

In some embodiments, the generated token may also be used for recurring payments, such that a token having the same or similar details may be regenerated on a recurring basis for use in authorizing a recurring payment. Although the token may have similar details and/or be generated to map to a same or similar agreement on a recurring basis, an alphanumeric string corresponding to the token identifier of the token may be different each time a token is generated for the recurring payment. In some embodiments, a token used for a recurring payment may have its validity period extended to match a validity period of the agreement to which it is mapped. Moreover, refunds may be processed by merchant device or server 104 through remote server 106 based on stored details of the token and/or agreement.

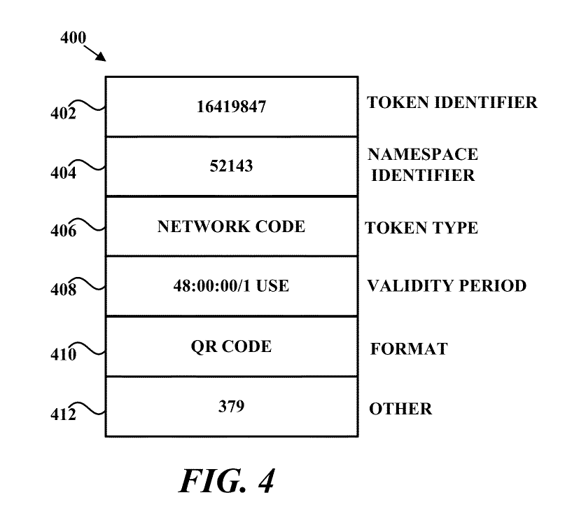

FIG. 4 is a diagram illustrating a token 400, consistent with some embodiments. As shown in FIG. 4, token 400 may include token identifier 402 that may be an alphanumeric string having any desired length. In some embodiments, the length may be between four and nine characters. In some embodiments, the shorter the length of token, the less valid the token may be and the fewer areas that token may be used. Token 400 may also include a namespace identifier 404. In some embodiments, a namespace may be a container or boundary for a set of identifiers and may be used to distinguish token identifiers within a particular namespace such that each generated token identifier 402 is unique within a particular namespace. Namespaces may be based on such information such as a country of user 110, an identification number of a merchant, a purpose of the token and token identifier 402, account information, a format of the token 400, and other information. Namespace identifier 404 may be an alphanumeric string that may be added to token identifier 402 to distinguish token identifier 402 within the namespace, to identify merchant or other details for use in a transaction, and/or to facilitate the use of certain transactions using token 400 such as card transactions. For example, a typical card number may be between 16-19 characters long while token identifier 402 may be between four and nine characters. In order to allow token to be used at merchant device or server 104 when merchant device or server 104 is set up to handle card transactions, namespace identifier 404 may be prepended to token identifier 402 to attempt to produce token 400 having the correct number of characters. In some embodiments, namespace identifier may correspond to a Banking Identification Number (BIN) or an Issuer Identification Number (IIN) that identifies a valid banking institution or card issuing institution, including institutions that are used by user when authorizing payments using remote server 106 and stored in account information 130. In some embodiments, namespace identifier 404 may not be needed or used in token 400, such that user 110 may authorize a payment to complete an agreement using token identifier 402. Token 400 generally may include an alphanumeric string or code that has a variable length and may include token identifier 402 and namespace identifier 404.

Token 400 may also include a token type 406. Token type 406 may include a network code token having a particular length, or a short code token that may have a length that is less than a length of network code token. In some embodiments, a short code token may take the form of a temporary passcode or temporary personal identification number (PIN) that user 110 may use to authenticate to remote server 106 temporarily for the purpose of authorizing a payment for an agreement. Token 400 may also include a validity period 408 which may specify for how long token 400 may be valid for use to authorize a payment to complete an agreement and how many times token 400 may be used to authorize a payment. Token 400 may also include a format 410. In some embodiments, format 410 may refer to how token 400 is presented. For example, format 410 may refer to a code, such as a bar code or QR code. Format 410 may also refer to a temporary passcode or PIN. Format 410 may further correspond to just an alphanumeric string that includes token identifier 402 and, in some embodiments, namespace identifier 404, that user 110 enters at merchant device or server 104 or reads to a merchant for entry at merchant device or server 104. Token 400 may also include other information 412. Other information 412 may include error checking codes, such as a checksum, which may be used by user device 102 to check the received token 400 for errors or other irregularities. In some embodiments, other information 412 may also be appended or prepended to token identifier 402 and/or namespace identifier 404 for creating a token 400 having an alphanumeric string having a particular character length. The components of token 400 shown in FIG. 4 are exemplary only, and token 400 may have more or less components in some embodiments.

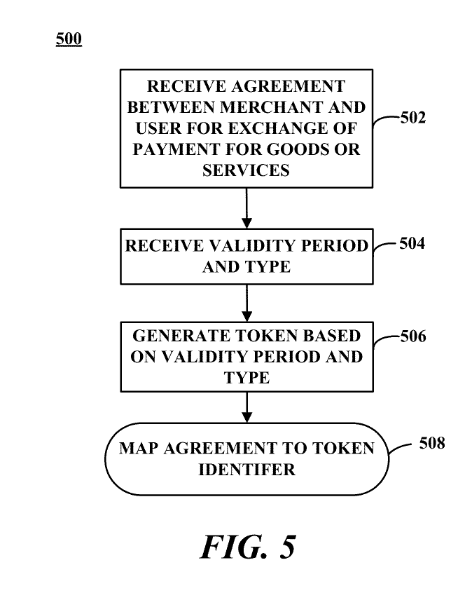

FIG. 5 is a flowchart illustrating a method for generating a token, consistent with some embodiments. For the purpose of illustration, FIG. 5 will be described with reference to any of FIGS. 1-4. The method shown in FIG. 5 may be embodied in computer-readable instructions for execution by one or more processors in processing component 206 such that the steps of the method may be performed by remote server 106, merchant device or server 104, or user device 102. As shown in FIG. 5, method 500 begins when remote server 106 receives an agreement between a merchant and user 110 for the exchange of payment for goods and/or services (502). In some embodiments, the received agreement may be formed by browser application 112 or payment application 114 of user device 102, merchant interface application or 120 or checkout application 120 of merchant device or server 104, agreement application 124 of remote server 106, or a combination thereof. The received agreement may include agreement details such as the goods and/or services to be exchanged, the amount of the payment to be made, merchant information, user information, and merchant location. The received agreement may be assigned an agreement identification, and stored by remote server 106 in any of account database 128, account information 130, or databases 134.

Token generation application 126 may also receive a validity period and token type (504). In some embodiments, a token type may include a network code token or a short code token that may have a length shorter than that of a network code token. A validity period may specify for how long the generated token is valid to be used to authorize a payment to complete an agreement. In some embodiments, additional information may also be received such as a format and additional details related to user 110 and the merchant for the purpose of, among other things, defining a namespace.

Based, in part on the received validity period and token type, token generation application 126 may generate a token 400 (506). In some embodiments, the generated token 400 may include a token identifier 402 which may be an alphanumeric string having between four and nine characters. Moreover, the token identifier 402 may be generated within a namespace defined according to the agreement. In some embodiments, the namespace may define at least one of a country, a merchant identification, an entity, and a format 410 of token 400. In some embodiments, the country portion of the namespace may refer to a general location of a merchant for knowing the currency and other relevant details pertaining to the merchant's location. The entity portion of the namespace may refer to user 110 and details associated with user 110, such as account information 130 for making a payment. Token 400 may include a namespace identifier 404 based on the namespace, wherein namespace identifier may be appended or prepended to token identifier 402 such that token 400 includes token identifier 402 and namespace identifier 404. In some embodiments, information defining the namespace may appear in namespace identifier 404, for example a ZIP code of a merchant, or a merchant or user 110 BIN number or IIN number. Token 400 may also have a format 410 such as a bar code or QR code. Format 410 may also refer to a temporary passcode or PIN. Token 400 may also include additional information 412, such as error checking information. The received agreement may then be mapped to the generated token 400 (508). If token 400 was generated by token generation application 126 of remote server, token 400 may then be sent to user device 102 over network 108 for use by user 110 to authorize a payment. Although the steps of method 500 have been primarily described as being performed by token generation application 126 of remote server 106, in some embodiments payment application 114 of user device 102 or merchant interface application 120 of merchant device or server 104 may perform the steps of method 500 to generate token 400.

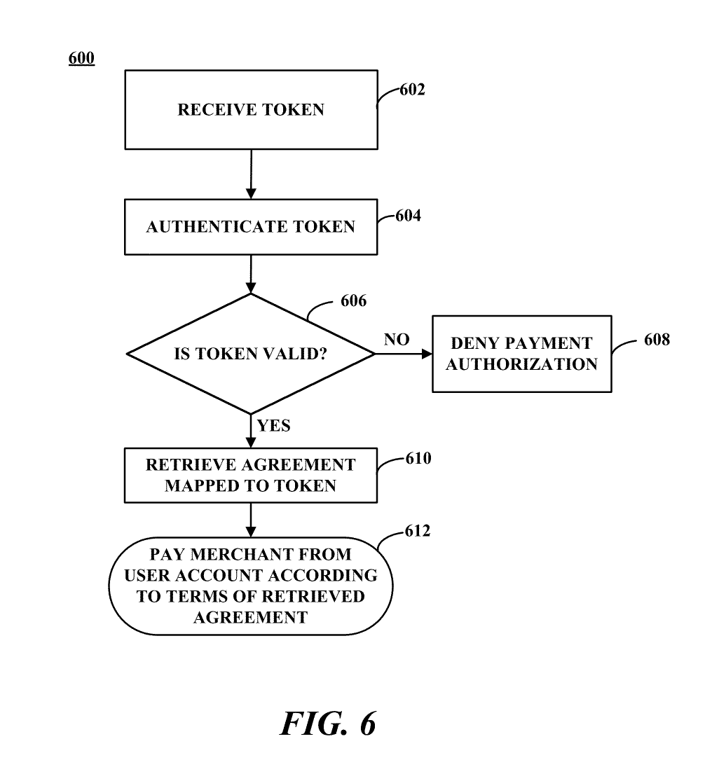

FIG. 6 is a flowchart illustrating a method for authorizing a payment based on a received token, consistent with some embodiments. For the purpose of illustration, FIG. 6 will be described with reference to any of FIGS. 1-4. The method shown in FIG. 6 may be embodied in computer-readable instructions for execution by one or more processors in processing component 206 such that the steps of the method may be performed by remote server 106, merchant device or server 104, or user device 102. As shown in FIG. 6, method 600 may begin when remote server 106 receives token 400 (602). In some embodiments, user 110 may present token 400 to merchant device or server 104 using user device 102 or by entering an alphanumeric identifier of token 400 at merchant device or server 104, and merchant device or server 104 may send the presented token 400 to remote server 106. In some embodiments, the presented token 400 may include token identifier 402 and, in some embodiments, additional information 412 and namespace identifier 404. Upon receiving token 400, remote server 106 may authenticate token 400 (604). In some embodiments, token 400 may be used to temporarily authenticate with remote server 106 for the purpose of authorizing a payment to complete an agreement.

Remote server 106 may determine if token 400 is valid (606). In some embodiments, token 400 may have an associated validity period and remote server 106 may determine if token 400 is received within the validity period. If token 400 is not valid, remote server 106 may deny the authentication and the authorization of a payment to fulfill the agreement (608). However, if token 400 is valid, remote server 106 may retrieve the agreement mapped to token 400 (610). In some embodiments, token 400 may have a token identifier 402 and remote server 106 may have an agreement for the exchange of a payment for goods and/or services mapped to token identifier 402 such that when remote server 106 receives token 400 having token identifier 402, remote server 106 retrieves the agreement from account database 128 or databases 134. Remote server 106 may then pay the merchant from an account associated with user 110 according to the terms of the retrieved agreement (612). In some embodiment, user 110 may have account information 130 from which remote server 106 can process a payment to complete the agreement authorized by token 400. In some embodiments, token 400 may specify additional payment details that may be used by remote server 106 to process a payment to complete the agreement. Although the steps of method 600 have been primarily described as being performed by remote server 106, in some embodiments, certain steps of method 600 may be performed by merchant interface application 120 or checkout application 122 of merchant device or server 104.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may provide systems and methods for generating and using a token for use in a transaction. In particular, systems and methods provided herein may provide a merchant and user with the ability to accept and pay for agreements using a variety of different payment methods. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system for generating a token for use in authorizing a payment, comprising:
a network interface component configured to:
receive an agreement for an exchange of the payment for goods or services;
receive a validity period defining a period for which the token is valid; and
receive a token type;
one or more processors configured to:
generate the token based on the validity period and token type; and
map the received agreement to the token; and
a memory configured to store the received agreement.

2. The system of claim 1, wherein the received agreement comprises an agreement between a merchant and a user.

3. The system of claim 1, wherein the received token type specifies that the token is one of a short code token and a network code token.

4. The system of claim 1, wherein the generated token comprises a token identifier within a predetermined namespace.

5. The system of claim 4, wherein the predetermined namespace defines at least one of a country, a merchant identification, an entity, and a purpose of the token.

6. The system of claim 4, wherein the generated token comprises a namespace identifier, the namespace identifier being appended or prepended to the token identifier such that the generated token includes an alphanumeric string having a particular length.

7. A computer-readable medium including instructions that, when executed by one or more processors, cause the one or more processors to perform a method for generating a token, the method comprising:
receiving an agreement for an exchange of payment for goods or services;
receiving a validity period defining a period over which the token is valid;
receiving a token type;
generating the token based on the validity period and token type; and
mapping the received agreement to the token.

8. The computer-readable medium of claim 7, wherein receiving an agreement comprises receiving an agreement between a merchant and a user.

9. The computer-readable medium of claim 7, wherein receiving a token type comprises receiving an indication that the token is one of a short code token and a network code token.

10. The computer-readable medium of claim 7, wherein the generated token comprises a token identifier having a length between four and nine characters.

11. The computer-readable medium of claim 10, wherein the generated token comprises a namespace identifier appended or prepended to the token identifier such that the generated token includes an alphanumeric string having a particular length.

12. The computer-readable medium of claim 10, wherein the token identifier is generated within a predetermined namespace.

13. The computer-readable medium of claim 12, wherein the predetermined namespace defines at least one of a country, a merchant identification, an entity, and a purpose of the token.

14. A computer-readable medium including instructions that, when executed by one or more processors, cause the one or more processors to perform a method for authorizing a payment using a token, the method comprising:
receiving the token;
authenticating the token;
retrieving an agreement for an exchange of the payment for goods and/or services mapped to the token; and
paying a merchant providing the goods and/or services from a user account according to terms of the retrieved agreement.

15. The computer-readable medium of claim 14, wherein receiving the token comprises receiving an alphanumeric string having a predetermined length.

16. The computer-readable medium of claim 15, wherein the received alphanumeric string comprises at least one of a token identifier and a namespace identifier.

17. The computer-readable medium of claim 16, wherein the alphanumeric string comprises the namespace identifier prepended or appended to the token identifier.

18. The computer-readable medium of claim 16, further comprising:
paying the merchant when the received token is valid based on a validity period associated with the received token; and
not paying the merchant when the received token is not valid based on the validity period.

19. The computer-readable medium of claim 16, wherein authenticating the token comprises initiating a temporary session according to the token identifier.

20. The computer-readable medium of claim 14, wherein receiving the token comprises scanning a code corresponding to the alphanumeric string.
